(19) United States
(12) Patent Application Publication
(10) Pub. No.: US 2025/0004897 A1
(43) Pub. Date: Jan. 2, 2025

(54) COMPUTER MANAGEMENT SYSTEM AND COMPUTER MANAGEMENT METHOD

(71) Applicant: Allxon Inc., Taipei City (TW)

(72) Inventors: Jung Hsuan Fan, Taipei City (TW); Yuan Hsiu Lee, Taipei City (TW)

(73) Assignee: Allxon Inc., Taipei City (TW)

(21) Appl. No.: 18/470,398

(22) Filed: Sep. 19, 2023

Related U.S. Application Data
(60) Provisional application No. 63/523,652, filed on Jun. 28, 2023.

(51) Int. Cl. G06F 11/30; H04L 41/344

(52) U.S. Cl. CPC G06F 11/3003; H04L 41/344

(57) ABSTRACT

A computer management system and a computer management method for remotely monitoring one or more computers are provided. The computer management system comprises a management server, an out-of-band hardware module, installed on each of the one or more computers, and an administration device. The management server is configured to monitor and control of the one or more computers. The out-of-band hardware module is configured to act as a client to connect to the management server via a network and monitor and control the respective computer in accordance with instructions sent from the management server. The administration device is configured to act as a client to connect to the management server via the network and instruct the out-of-band hardware module to perform the monitoring and controlling of the respective computer through the management server.

### CROSS-REFERENCE TO RELATED APPLICATION

This application claims the priority benefit of U.S. provisional application Ser. No. 63/523,652, filed on Jun. 28, 2023. The entirety of the above-mentioned patent application is hereby incorporated by reference herein and made a part of this specification.

### BACKGROUND

### Technical Field

The disclosure relates to a management system and a management method, and particularly relates to a computer management system and a computer management method.

### Description of Related Art

Due to aging or environmental factors, hardware or software of computers may malfunction from time to time. This can be detrimental to business operations. A fast recovery is critical. In the era of Internet of Things (IoT), computers are often decentralized and geographically dispersed. Remote management and disaster recovery are required.

A remote computer management based on an out-of-band architecture has been developed in the past and allows efficient recovery of such a disaster. FIG. 1A and FIG. 1B respectively depict a conventional baseboard management controller (BMC)-based computer management system. Referring to FIG. 1A, a computer management system 10 includes a management administration computer 12 situated in an out-of-band local area network (LAN) and includes BMC 1 and BMC 2 respectively installed on Computer 1 and Computer 2. Each of the BMC 1 and the BMC 2 acts as a server and the management administration computer 12 acts as a client to connect to the BMC 1 according to the Internet protocol (IP) address IP1 and connect to the BMC 2 according to the IP address IP2.

Referring to FIG. 1B, a computer management system 10a includes a management administration computer 12a situated in the cloud. A virtual private network (VPN) server 18 is usually required for BMC 3 and BMC 4, respectively installed on Computer 3 and Computer 4, to connect to Internet 14 through a firewall 16.

A typical process flow of the BMC-based computer management system 10 consists of the following steps: (1) the management administration computer 12 identifies each BMC by its preconfigured IP address; (2) the management administration computer 12 makes connection to each BMC based on its IP address; (3) the management administration computer 12 monitors the hardware of each computer associated with each BMC; (4) the hardware status of each monitored computer is stored in the memory of its BMC; and (5) when the hardware status of a monitored computer indicates an abnormality, the management administration computer 12 controls the computer to remedy the abnormality via its BMC.

However, the above structure and functionality of the BMC-based computer management system 10 have following issues: (a) each BMC chip is CPU dependent and its functionality is preset and fixed; (b) Each BMC functions as a server and therefore, the management administration computer 12 could only monitor and control one BMC at a time; (c) the BMC-based management could only monitor and control the hardware of a computer; (d) any computer without a BMC chip preinstalled cannot be retrofitted for BMC-based management; and (e) the cost of a BMC chip is high due to its complexity, and hence it is normally installed only on more expensive computers, such as servers.

### SUMMARY

The disclosure provides a computer management system and a computer management method capable of performing monitoring of one or more computers with low cost.

In an embodiment of the disclosure, a computer management system for remotely monitoring and controlling one or more computers is provided. The computer management system comprises a management server, an out-of-band hardware module, installed on each of the one or more computers, and an administration device. The management server is configured to monitor and control of the one or more computers. The out-of-band hardware module is configured to act as a client to connect to the management server via a network and monitor and control the respective computer in accordance with instructions sent from the management server. The administration device is configured to act as a client to connect to the management server via the network and instruct the out-of-band hardware module to perform the monitoring and controlling of the respective computer through the management server.

According to an embodiment of the disclosure, the out-of-band hardware module comprises a network connecting device, an input/output (I/O) device, a storage device, and a processor. The network connecting device is configured to connect to the network. The I/O device is configured to connect to one or more monitoring devices and one or more controlling devices installed on the respective computer. The storage device is configured to store an out-of-band agent (OOBA) program for performing the monitoring and controlling of the respective computer. The processor is coupled to the network connecting device, the I/O device and the storage device, and configured to execute the OOBA program to receive the instructions of the management server by the network connecting device, receive, by the I/O device, data from the one or more monitoring devices, and send, by the I/O device, commands to the one or more controlling devices to monitor and control the respective computer in accordance with the instructions.

According to an embodiment of the disclosure, the one or more monitoring devices comprise one or more sensors for detecting a temperature, a humidity, or an intrusion, and the one or more controlling devices are for power cycling or solid state drive (SSD) recovery.

According to an embodiment of the disclosure, the out-of-band hardware module is preconfigured with an identification (ID) number, and the processor is configured to request a connection with the management server using the ID number when the out-of-band hardware module is powered on and establish the connection when the ID number is authorized by the management server.

According to an embodiment of the disclosure, the administration device identifies the respective out-of-band hardware modules based on the ID numbers so as to instruct the out-of-band hardware module to perform the monitoring and controlling of the respective computer.

According to an embodiment of the disclosure, the processor further determines a hardware status of the computer according to the data and uploads the determined hardware status to the management server by the network connecting device, or uploads the data to the management server by the network connecting device for the management server to determine and store the hardware status of the computer.

According to an embodiment of the disclosure, when the hardware status indicates an abnormality of one or more hardware components in the computer, the administration device further instructs the out-of-band hardware module in the computer to fix the abnormality.

According to an embodiment of the disclosure, the out-of-band hardware module further comprises a serial port, which is configured to connect to the computer, wherein the OOBA program communicates with an in-band agent (IBA) program installed in the computer through the serial port and instructs the IBA program to perform the monitoring and controlling of the computer.

According to an embodiment of the disclosure, the processor further receives data from the IBA program and uploads the data to the management server by the network connecting device for the management server to determine and store a hardware status or a software status of the computer.

According to an embodiment of the disclosure, when the software status indicates an abnormality of one or more software applications in the computer or the hardware status indicates an abnormality of one or more hardware components in the computer, the administration device further instructs the out-of-band hardware module in the computer to fix the abnormality through communication with the IBA program.

In an embodiment of the disclosure, a computer management method for remotely monitoring and controlling one or more computers, adapted for a computer management system having a management server, an out-of-band hardware module installed on each of the one or more computers, and an administration device, is provided. In the method, the out-of-band hardware module acts as a client to connect to the management server via a network, the administration device acts as a client to connect to the management server via the network and instruct the out-of-band hardware module to perform monitoring and controlling of the respective computer through the management server, and the out-of-band hardware module monitors and controls the respective computer in accordance with instructions sent from the management server.

According to an embodiment of the disclosure, the step of the out-of-band hardware module monitoring and controlling the respective computer in accordance with instructions sent from the management server comprises receiving the instructions from the management server, receiving data from the one or more monitoring devices, and sending commands to the one or more controlling devices to monitor and control the respective computer in accordance with the instructions.

According to an embodiment of the disclosure, the one or more monitoring devices comprise one or more sensors for detecting a temperature, a humidity, or an intrusion, and the one or more controlling devices are for power cycling or solid state drive (SSD) recovery.

According to an embodiment of the disclosure, the out-of-band hardware module is preconfigured with an ID number, and the step of the out-of-band hardware module acting as the client to connect to the management server via the network comprises requesting a connection with the management server using the ID number when the out-of-band hardware module is powered on, and establishing the connection when the ID number is authorized by the management server.

According to an embodiment of the disclosure, the step of the administration device instructing the out-of-band hardware module to perform monitoring and controlling of the respective computer through the management server comprises the administration device identifying the respective out-of-band hardware modules based on the ID numbers so as to instruct the monitoring and controlling of the one or more computers.

According to an embodiment of the disclosure, the method further comprises the out-of-band hardware module determining a hardware status of the computer according to the data and uploading the determined hardware status to the management server, or uploading the data to the management server for the management server to determine and store the hardware status of the computer.

According to an embodiment of the disclosure, the method further comprises when the hardware status indicates an abnormality of one or more hardware components in the computer, the administration device instructing the out-of-band hardware module in the computer to fix the abnormality.

According to an embodiment of the disclosure, the method further comprises the out-of-band hardware module connecting to the computer through a serial port, and an out-of-band agent (OOBA) program installed in the out-of-band hardware module communicating with an in-band agent (IBA) program installed in the computer through the serial port and instructing the IBA program to perform the monitoring and controlling on the computer.

According to an embodiment of the disclosure, the method further comprises the out-of-band hardware module receiving data from the IBA program and uploading the data to the management server for the management server to determine and store a hardware status or a software status of the computer.

According to an embodiment of the disclosure, the method further comprises when the software status indicates an abnormality of one or more software applications in the computer or the hardware status indicates an abnormality of one or more hardware components in the computer, the administration device instructing the out-of-band hardware module in the computer to fix the abnormality through communication with the IBA program.

To make the above mentioned more comprehensible, several embodiments accompanied by drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B respectively depict a conventional baseboard management controller (BMC)-based computer management system.

FIG. 2 depicts an architecture of a computer management system according to an exemplary embodiment of the disclosure.

FIG. 3 depicts an architecture of the out-of-band hardware module 24 according to an exemplary embodiment of the disclosure.

FIG. 4 depicts a flow chart of a computer management method according to an exemplary embodiment of the disclosure.

FIG. 5 depicts a flow chart of a computer management method according to an exemplary embodiment of the disclosure.

FIG. 6 depicts an architecture of a computer management system according to an exemplary embodiment of the disclosure.

FIG. 7 depicts an architecture of the out-of-band hardware module 64 according to an exemplary embodiment of the disclosure.

FIG. 8 depicts a flow chart of a computer management method according to an exemplary embodiment of the disclosure.

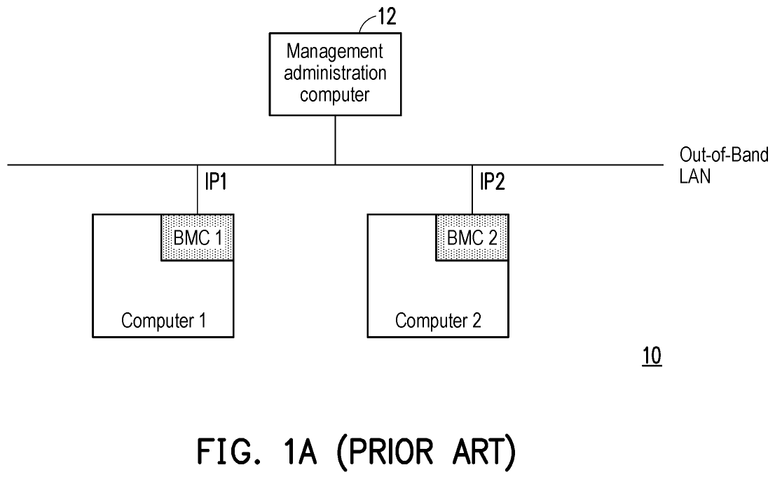

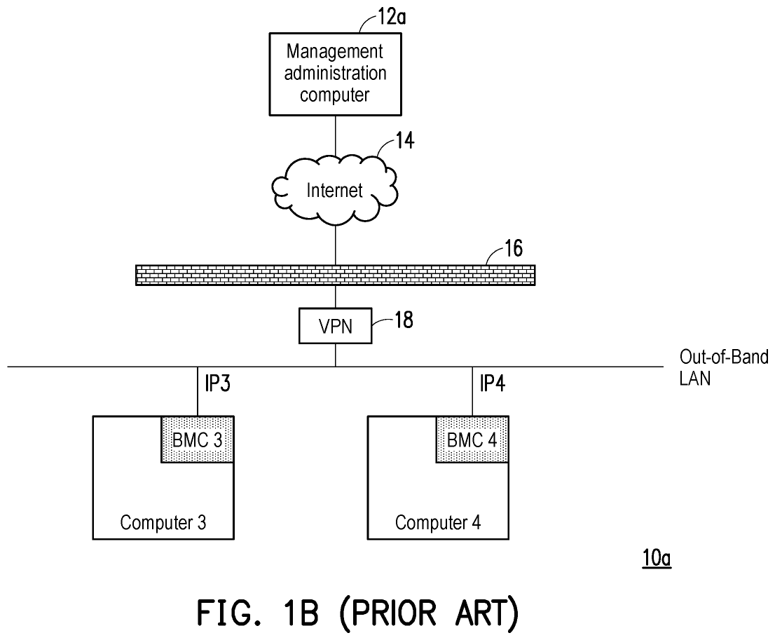

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

As illustrated above, the conventional BMC-based computer management system have following drawbacks: (a) each BMC chip is CPU dependent and its functionality is preset and fixed; (b) Each BMC functions as a server and therefore, the management administration computer 12 could only monitor and control one BMC at a time; (c) the BMC-based management could only monitor and control the hardware of a computer; (d) any computer without a BMC chip preinstalled cannot be retrofitted for BMC-based management; and (e) the cost of a BMC chip is high due to its complexity, and hence it is normally installed only on more expensive computers, such as servers.

Accordingly, the present invention provides solutions to the drawbacks of the conventional BMC-based computer management system: (1) the computer management system can be applied to computers with any CPU architecture, and the functionally thereof is programmable with the deployment of two software agents, that is, the out-of-band agent (OOBA) program installed on an out-of-band hardware module and an in-band agent (IBA) software installed on the computer, thus allowing both flexibility and expandability for its applications; (2) the out-of-band hardware module functions as a client to the management server and hence, multiple computers can be monitored and controlled simultaneously; (3) both hardware and software status of a computer can be monitored and controlled; (4) the out-of-band hardware module can be retrofitted to any computer already in operation; and (5) the cost of the out-of-band hardware module can be a fraction of the BMC, and hence the out-of-band hardware module can be installed on a wide range of computing devices.

The present invention provides an out-of-band computer management system for remotely monitoring and controlling the hardware and software of one or more computers, in which an out-of-band hardware module is installed on each of the computers to be monitored and controlled, and acts as a client to connect to a management server and hence, both hardware and software of multiple computers can be monitored and controlled simultaneously. In addition to controlling the monitoring devices and the controlling devices installed on the computer to obtain hardware-related data, the out-of-band hardware module may communicate with a programmable in-band agent (IBA) software installed on the computer to obtain software-related data, and upload those data to the management server. As such, the management server is able to determine a hardware status and/or a software status of each computer and an administration device of a user may instruct the out-of-band hardware modules to fix the abnormality raised in the computers to achieve remote monitoring, controlling and maintenance of multiple computers.

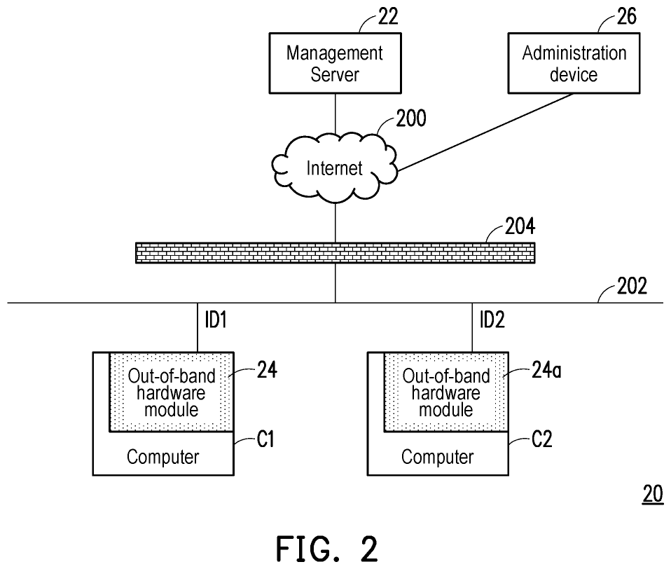

FIG. 2 depicts an architecture of a computer management system according to an exemplary embodiment of the disclosure. Referring to FIG. 2, the computer management system 20 includes a management server 22, an out-of-band hardware module 24 installed on a computer C1, an out-of-band hardware module 24a installed on a computer C2, and an administration device 26. The number of the computers is taken as an example in the present embodiment, but the invention is not limited thereto.

The management server 22 is, for example, a personal computer, a fileserver, a webserver, a database server, a workstation, or other devices with computing functions. The management server 22 includes a processor for performing management of connections and monitoring and controlling of various computers, and a memory for storing identification (ID) numbers of the computes being connected (e.g ID numbers ID1 and ID2 of the computers C1 and C2) and a hardware and/or software status of each computer.

The out-of-band hardware modules 24 and 24a are electronic devices situated in an out-of-band local area network (LAN) 202 and capable of connecting to Internet 200 through a firewall 204. The out-of-band hardware modules 24 and 24a further connect to one or more monitoring devices and one or more controlling devices in the respective computers such as sensors for detecting a temperature, a humidity, or an intrusion, and the one or more controlling devices are for power cycling or solid state drive (SSD) recovery so as to receive data from the monitoring devices and send commands to the controlling devices to monitor and control the respective computer. In the present embodiment, the out-of-band hardware modules 24 and 24a act as a client to connect to the management server 22 through the Internet 200 and upload the data to the management server 22 such that the management server 22 is capable of determining a hardware and/or software status of the computers C1 and C2 based on the data and storing the same in the memory. However, in other embodiments, the out-of-band hardware modules 24 and 24a may determine a hardware and/or software status of the computers C1 and C2 based on the data and act as a client to connect to the management server 22 through the Internet 200 and upload the determined hardware and/or software status of the computers C1 and C2 to the management server 22.

The administration device 26 is, for example, a desktop, a laptop, a smartphone, or other devices with computing functions, and serves as an interface for an administrator or a user to access the management server 22 and instruct the out-of-band hardware modules 24 and 24a to perform monitoring and controlling of the respective computers C1 and C2 through the management server 22. In the present embodiment, the administration device 26 also acts as a client to connect to the management server 22 through the Internet 200, accesses the hardware and/or software status of the computers C1 and C2 stored in the memory of the management server 22 and displays the same on a user interface for the administrator or the user to review.

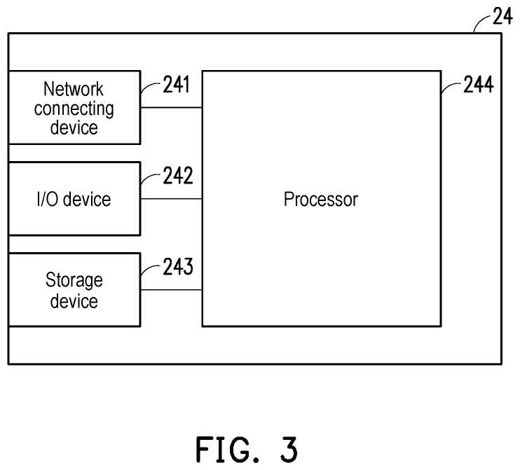

FIG. 3 depicts an architecture of the out-of-band hardware module 24 according to an exemplary embodiment of the disclosure. Referring to FIG. 2 and FIG. 3, the out-of-band hardware module 24 includes a network connecting device 241, an input/output (I/O) device 242, a storage device 243, and a processor 244.

The network connecting device 241 is, for example, a network card supporting Ethernet or supporting wireless network standards such as 802.11g, 802.11n, 802.11ac, etc., so that the out-of-band hardware module 24 may connect to the network and transmit data through the network.

The I/O device 242 is, for example, a wired or wireless transmission interface supporting universal serial bus (USB), RS232, Bluetooth (BT), or wireless fidelity (Wi-Fi) and is configured to connect to one or more monitoring devices and controlling devices installed on the computer C1.

The storage device 243 is, for example, a fixed or movable random access memory (RAM) in any form, a read-only memory (ROM), a flash memory, a hard disk, or other similar devices or a combination of the foregoing devices and is configured to store a programmable out-of-band agent (OOBA) program which may be executed by the processor 244 for performing the monitoring and controlling of the computer C1.

The processor 244 is coupled to the network connecting device 241, the I/O device 242 and the storage device 243, and is, for example, a central processing unit (CPU), a microcontroller unit (MCU), a programmable microprocessor, a digital signal processor (DSP), an application specific integrated circuits (ASIC), a programmable logic controller (PLC), or other similar devices or a combination of these devices, and may execute the OOBA program stored in the storage device 243 to perform the monitoring and controlling of the computer C1.

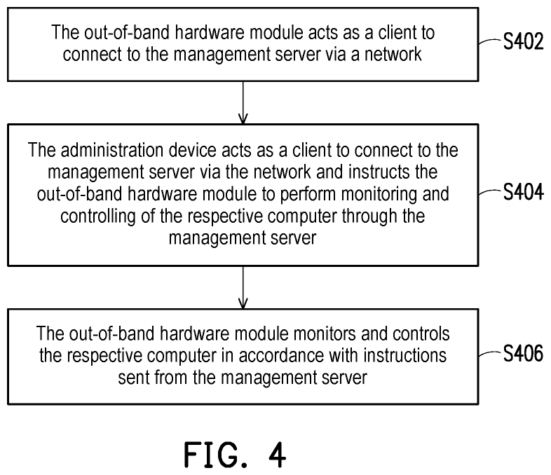

FIG. 4 depicts a flow chart of a computer management method according to an exemplary embodiment of the disclosure. With reference to FIG. 2, FIG. 3 and FIG. 4 together, the method provided by this embodiment is adapted for the computer management system 20 in FIG. 2, and steps of the method are described in detail below with reference to the management server 22, the out-of-band hardware module 24, and the administration device 26 in the computer management system 20.

First, in step S402, the out-of-band hardware module 24 acts as a client to connect to the management server 22 via a network. In some embodiments, the out-of-band hardware module 24 may connect to the management server 22 through the out-of-band LAN 202 if the management server 22 is situated in the out-of-band LAN 202, or connect to the management server 22 through the out-of-band LAN 202 and the Internet 200 if the management server 22 is situated in the cloud, which should not be construed as a limitation in the disclosure.

It is noted, each of the out-of-band hardware modules 24 and 24a is preconfigured with a unique identification (ID) number (e.g. ID1 for the out-of-band hardware module 24) in a factory, such that, when the out-of-band hardware module 24 is powered on with its associated computer C1, the processor 244 of the out-of-band hardware module 24 may automatically request a connection with the management server 22 using the ID number ID1 by the network connecting device 241 and establish the connection when the ID number ID1 is authorized by the management server 22.

Then, in step S404, the administration device 26 acts as a client to connect to the management server 22 via the network and instruct the out-of-band hardware module 24 to perform monitoring and controlling of the computer C1 through the management server 22. In some embodiments, the administration device 26 may identify the out-of-band hardware module 24 based on the ID number ID1 stored in the management server 22 so as to instruct the out-of-band hardware module 24 to perform the monitoring and controlling of the computer C1.

Finally, in step S406, the out-of-band hardware module 24 monitors and controls the computer C1 in accordance with instructions sent from the management server 22. In some embodiments, the processor 244 of the out-of-band hardware module 24 may receive the instructions from the management server 22 by the network connecting device 241, receive, by the I/O device 242, data from the monitoring devices and send commands to the controlling devices to monitor and control, by the I/O device 242, the computer C1 in accordance with the instructions.

Through the method above, since each of the out-of-band hardware module installed on the respective computer acts as a client to connect to a management server so as to perform monitoring and controlling of the computer in accordance with the instructions received from the management server, multiple computers can be monitored and controlled simultaneously.

It is noted, in some embodiments, the out-of-band hardware module may upload the data to the management server for the management server to determine and store a hardware status of the computer. When the hardware status indicates an abnormality of one or more hardware components in the computer, the administration device may instruct the out-of-band hardware module in the computer to fix the abnormality.

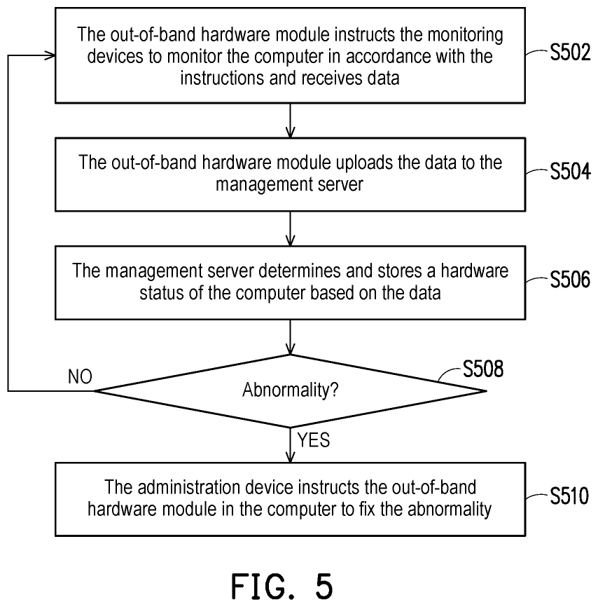

FIG. 5 depicts a flow chart of a computer management method according to an exemplary embodiment of the disclosure. With reference to FIG. 2, FIG. 3 and FIG. 5 together, the method provided by this embodiment is adapted for the computer management system 20 in FIG. 2, and steps of the method are described in detail below with reference to the management server 22, the out-of-band hardware module 24, and the administration device 26 in the computer management system 20.

First, in step S502, the out-of-band hardware module 24 instructs the monitoring devices installed on the computer C1 to monitor the computer C1 in accordance with the instructions sent from the management server 22 and receives data from the monitoring devices by the I/O device 242.

In step S504, the out-of-band hardware module 24 uploads the data to the management server 22 by the network connecting device 241.

In step S506, the management server 22 determines and stores a hardware status of the computer C1 based on the data. In some embodiments, the management server 22 may store various criteria for determining the hardware status of the computer such as thresholds of power cycling, temperature, humidity or other factors that may result in malfunction of the computer. The management server 22 may compare the received data with respective threshold so as to determine the hardware status of the computer. The hardware status may indicate an abnormality of one or more hardware components in the computer, but the embodiment is not limited thereto.

In some embodiments, the out-of-band hardware module 24 determines a hardware status of the computer Cl according to the data and uploads the determined hardware status to the management server 22 by the network connecting device 241.

In step S508, the administration device 26 checks the hardware status stored in the management server 22 to determine whether the hardware status indicates an abnormality of one or more hardware components in the computer C1.

If the hardware status indicates the abnormality, in step S510, the administration device 26 instructs the out-of-band hardware module 24 in the computer C1 to fix the abnormality. Otherwise, the flow returns back to step S502 such that the out-of-band hardware module 24 keeps monitoring the computer C1. In some embodiments, the administration device 26 instructs the out-of-band hardware module 24 to raise a fan speed to lower down the temperature of the computer C1 when the hardware status indicates overheating in the computer C1.

Through the method above, the administrator of the computers may monitor the hardware status of multiple computers so as to fix the abnormality raised in the computers. As a result, remote monitoring and maintenance of multiple computers can be achieved.

In some embodiments, the out-of-band hardware module may further include a serial port that is used to connect to the computer, such that the OOBA program in the out-of-band hardware module may communicate with the IBA program installed in the computer through the serial port and instruct the IBA program to perform the monitoring and controlling of the computer.

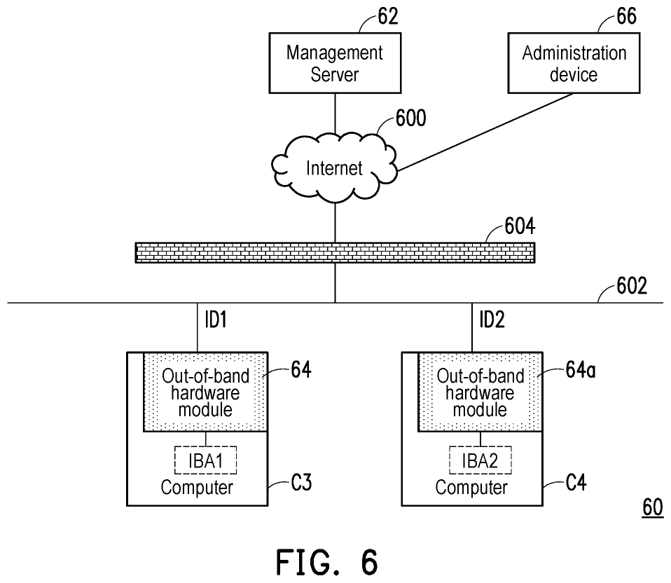

FIG. 6 depicts an architecture of a computer management system according to an exemplary embodiment of the disclosure. Referring to FIG. 6, the computer management system 60 includes a management server 62, an out-of-band management (OOBM) device 64 installed on a computer C3, an out-of-band hardware module 64a installed on a computer C4, and an administration device 66. The number of the computers and the out-of-band hardware modules is taken as an example in the present embodiment, but the invention is not limited thereto.

The management server 62 is, for example, a personal computer, a fileserver, a webserver, a database server, a workstation, or other devices with computing functions. The management server 22 includes a processor for performing management of connections and monitoring of various computers, and a memory for storing identification (ID) numbers of the computes being connected (e.g ID numbers ID3 and ID4 of the computers C3 and C4) and a hardware and/or software status of each computer.

The out-of-band hardware modules 64 and 64a are electronic devices situated in an out-of-band local area network (LAN) 602 and capable of connecting to Internet 600 through a firewall 604. The out-of-band hardware modules 64 and 64a further connect to one or more monitoring devices and one or more controlling devices installed on the respective computers so as to receive data from the monitoring devices. The monitoring devices are sensors for detecting a temperature, a humidity, or an intrusion, and the controlling devices are for power cycling or solid state drive (SSD) recovery. In the present embodiment, the out-of-band hardware modules 64 and 64a act as a client to connect to the management server 62 through the Internet 600 and upload the data to the management server 62 such that the management server 62 is capable of determining a hardware and/or software status of the computers C3 and C4 based on the data and storing the same in the memory.

The administration device 66 is, for example, a desktop, a laptop, a smartphone, or other devices with computing functions, and serves as an interface for an administrator or a user to access the management server 62 and instruct the out-of-band hardware modules 64 and 64a to perform monitoring and controlling of the respective computers C3 and C4 through the management server 62. In the present embodiment, the administration device 66 also acts as a client to connect to the management server 62 through the Internet 600, accesses the hardware and/or software status of the computers C3 and C4 stored in the memory of the management server 62 and displays the same on a user interface for the administrator or the user to review.

Differ from the computer management system 20 illustrated in FIG. 2, in the computer management system 60 of the present embodiment, the out-of-band hardware modules 64 and 64a in the computers C3 and C4 further connect to the computers C3 and C4 such that the OOBA programs of the out-of-band hardware modules 64 and 64a may communicate with the IBA programs IBA1 and IBA2 installed in the respective computers C3 and C4 and instruct the IBA programs IBA1 and IBA2 to perform monitoring and controlling on the respective computers C3 and C4. In some embodiments, the out-of-band hardware modules 64 and 64a may connect to the computers C3 and C4 via serial ports or other communication interfaces, which should not be construed as a limitation in the disclosure.

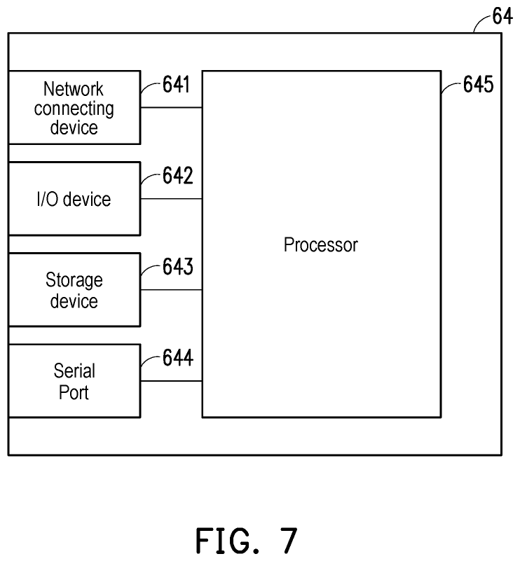

FIG. 7 depicts an architecture of the out-of-band hardware module 64 according to an exemplary embodiment of the disclosure. Referring to FIG. 6 and FIG. 7, the out-of-band hardware module 64 includes a network connecting device 641, an I/O device 642, a storage device 643, a serial port 644 and a processor 645. The functions and configurations of the network connecting device 641, the I/O device 642, the storage device 643, and the processor 645 are the same as or similar to those of the network connecting device 241, the I/O device 242, the storage device 243, and the processor 244 in FIG. 3, and thus the detailed descriptions are omitted herein.

Differ from the out-of-band hardware module 24 illustrated in FIG. 3, the out-of-band hardware module 64 of the present embodiment further includes the serial port 644 which is coupled to the processor 645 such that the processor 645 when executing the OOBA program stored in the storage device 643 may communicate with the IBA program IBA1 installed in the computer C3 through the serial port 644 and instruct the IBA program IBA1 to perform the monitoring and controlling of the computer C3.

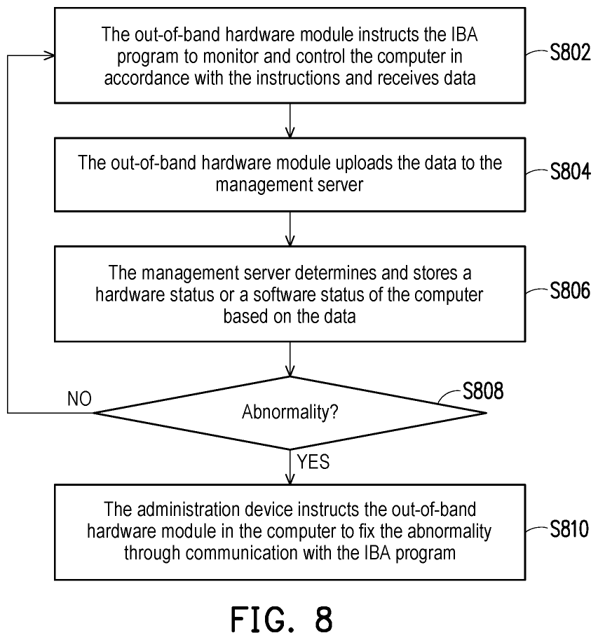

FIG. 8 depicts a flow chart of a computer management method according to an exemplary embodiment of the disclosure. With reference to FIG. 6, FIG. 7 and FIG. 8 together, the method provided by this embodiment is adapted for the computer management system 60 in FIG. 6, and steps of the method are described in detail below with reference to the management server 62, the out-of-band hardware module 64, and the administration device 66 in the computer management system 60.

First, in step S802, the out-of-band hardware module 64 instructs the IBA program IBA1 installed in the computer C3 to monitor and control the computer C3 in accordance with the instructions sent from the management server 62 and receives data from the IBA program IBA1 by the serial port 644.

In step S804, the out-of-band hardware module 64 uploads the data to the management server 62 by the network connecting device 641.

In step S806, the management server 62 determines and stores a hardware status or a software status of the computer C3 based on the data. The hardware status may indicate an abnormality of one or more hardware components in the computer C3 while the software status may indicate an abnormality of one or more software applications installed in the computer C3, but the embodiment is not limited thereto.

In step S808, the administration device 66 checks the hardware status or the software status stored in the management server 62 to determine whether the hardware status or the software status indicates an abnormality of the computer C3.

If the hardware status or the software status indicates the abnormality, in step S810, the administration device 66 instructs the out-of-band hardware module 64 in the computer C3 to fix the abnormality through communication with the IBA program IBA1. Otherwise, the flow returns back to step S802 such that the out-of-band hardware module 64 keeps monitoring and controlling the computer C3. In some embodiments, the administration device 66 instructs the out-of-band hardware module 24 to update the software application appeared to be abnormal through communication with the IBA program IBA1, but the embodiment is not limited thereto.

Through the method above, the administrator of the computers may monitor the hardware status and/or software status of multiple computers so as to fix the abnormality raised in the computers. As a result, remote monitoring and maintenance of multiple computers can be achieved.

To sum up, the computer management system and the computer management method of the present invention provide solutions to the drawbacks of the current BMC-based computer management system as: (1) the computer management system can be applied to computers with any CPU architecture, and the functionally thereof is programmable with the deployment of two software agents, that is, the OOBA program and the IBA program, thus allowing both flexibility and expandability for its applications; (2) the out-of-band hardware module functions as a client to the management server and hence, multiple computers can be monitored and controlled simultaneously; (3) both hardware and software status of a computer can be monitored and controlled; (4) the out-of-band hardware module can be retrofitted to any computer already in operation; and (5) the cost of the out-of-band hardware module can be a fraction of the BMC, and hence the out-of-band hardware module can be installed on a wide range of computing devices.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

1. A computer management system for remotely monitoring and controlling one or more computers, comprising:
a management server, configured to monitor and control the one or more computers;
an out-of-band hardware module, installed on each of the one or more computers, and configured to act as a client to connect to the management server via Internet such that the one or more computers are monitored and controlled simultaneously in accordance with instructions sent from the management server; and
an administration device, configured to act as a client to connect to the management server via the Internet and instruct the out-of-band hardware module to perform the monitoring and controlling of the respective computer through the management server.

2. The computer management system according to claim 1. wherein the out-of-band hardware module comprises:
a network connecting device, configured to connect to the Internet;
an input/output (I/O) device, configured to connect to one or more monitoring devices and one or more controlling devices installed on the respective computer;
a storage device, configured to store an out-of-band agent (OOBA) program for performing the monitoring and controlling of the respective computer; and
a processor, coupled to the network connecting device, the I/O device and the storage device, and configured to execute the OOBA program to receive the instructions of the management server by the network connecting device, receive, by the I/O device, data from the one or more monitoring devices, and send, by the I/O device, commands to the one or more controlling devices to monitor and control the respective computer in accordance with the instructions.

3. The computer management system according to claim 2, wherein the one or more monitoring devices comprise one or more sensors for detecting a temperature, a humidity, or an intrusion, and the one or more controlling devices are for power cycling or solid state drive (SSD) recovery.

4. The computer management system according to claim 2, wherein the out-of-band hardware module is preconfigured with an identification (ID) number, and the processor is configured to request a connection with the management server using the ID number when the out-of-band hardware module is powered on and establish the connection when the ID number is authorized by the management server.

5. The computer management system according to claim 4, wherein the administration device identifies the respective out-of-band hardware modules based on the ID numbers so as to instruct the out-of-band hardware module to perform the monitoring and controlling of the respective computer.

6. The computer management system according to claim 2, wherein the processor further determines a hardware status of the computer according to the data and uploads the determined hardware status to the management server by the network connecting device, or uploads the data to the management server by the network connecting device for the management server to determine and store the hardware status of the computer.

7. The computer management system according to claim 6, wherein when the hardware status indicates an abnormality of one or more hardware components in the computer, the administration device further instructs the out-of-band hardware module in the computer to fix the abnormality.

8. The computer management system according to claim 2, wherein the out-of-band hardware module further comprises:
a serial port, configured to connect to the computer, wherein the OOBA program communicates with an in-band agent (IBA) program installed in the computer through the serial port and instructs the IBA program to perform the monitoring and controlling of the computer.

9. The computer management system according to claim 8, wherein the processor further receives data from the IBA program and uploads the data to the management server by the network connecting device for the management server to determine and store a hardware status or a software status of the computer.

10. The computer management system according to claim 9, wherein when the software status indicates an abnormality of one or more software applications in the computer or the hardware status indicates an abnormality of one or more hardware components in the computer, the administration device further instructs the out-of-band hardware module in the computer to fix the abnormality through communication with the IBA program.

11. A computer management method for remotely monitoring and controlling one or more computers, adapted for a computer management system having a management server, an out-of-band hardware module installed on each of the one or more computers, and an administration device, the method comprising:
the out-of-band hardware module acting as a client to connect to the management server via Internet; and
the administration device acting as a client to connect to the management server via the Internet and instruct the out-of-band hardware module to perform monitoring and controlling of the respective computer through the management server, wherein
the one or more computers are monitored and controlled simultaneously in accordance with instructions sent from the management server.

12. The method according to claim 11, wherein the step of the out-of-band hardware module monitoring and controlling the respective computer in accordance with instructions sent from the management server comprises:
receiving the instructions from the management server:
receiving data from the one or more monitoring devices; and
sending commands to the one or more controlling devices to monitor and control the respective computer in accordance with the instructions.

13. The method according to claim 12, wherein the one or more monitoring devices comprise one or more sensors for detecting a temperature, a humidity, or an intrusion, and the one or more controlling devices are for power cycling or solid state drive (SSD) recovery.

14. The method according to claim 12, wherein the out-of-band hardware module is preconfigured with an identification (ID) number, and the step of the out-of-band hardware module acting as the client to connect to the management server via the Internet comprises:
requesting a connection with the management server using the ID number when the out-of-band hardware module is powered on; and
establishing the connection when the ID number is authorized by the management server.

15. The method according to claim 14, wherein the step of the administration device instructing the out-of-band hardware module to perform monitoring and controlling of the respective computer through the management server comprises:
the administration device identifying the respective out-of-band hardware modules based on the ID numbers so as to instruct the monitoring and controlling of the one or more computers.

16. The method according to claim 12, further comprising:
the out-of-band hardware module determining a hardware status of the computer according to the data and uploading the determined hardware status to the management server, or uploading the data to the management server for the management server to determine and store the hardware status of the computer.

17. The method according to claim 16, further comprising:
when the hardware status indicates an abnormality of one or more hardware components in the computer, the administration device instructing the out-of-band hardware module in the computer to fix the abnormality.

18. The method according to claim 12, further comprising:
the out-of-band hardware module connecting to the computer through a serial port; and
an out-of-band agent (OOBA) program installed in the out-of-band hardware module communicating with an in-band agent (IBA) program installed in the computer through the serial port and instructing the IBA program to perform the monitoring and controlling on the computer.

19. The method according to claim 18, further comprising:
the out-of-band hardware module receiving data from the IBA program and uploading the data to the management server for the management server to determine and store a hardware status or a software status of the computer.

20. The method according to claim 19, further comprising:
when the software status indicates an abnormality of one or more software applications in the computer or the hardware status indicates an abnormality of one or more hardware components in the computer, the administration device instructing the out-of-band hardware module in the computer to fix the abnormality through communication with the IBA program.
